(19) United States
(12) Patent Application Publication
(10) Pub. No.: US 2006/0061765 A1
(43) Pub. Date: Mar. 23, 2006

(54) Turbidity sensor with improved noise rejection

(76) Inventors: Behzad Rezvani, Anaheim, CA (US); Jeffrey Lomibao, Corona, CA (US)

Correspondence Address: WESTMAN, CHAMPLIN & KELLY, P.A.;International Centre, Suite 1400, 900 Second Avenue South, Minneapolis, MN, 55402-3319, US

(21) Appl. No.: 11/225,396

(22) Filed: Sep. 13, 2005

Related U.S. Application Data
(60) Provisional application No. 60/610,325, filed on Sep. 16, 2004.

(51) Int. Cl. G01N 21/00

(52) U.S. Cl. 356/442

(57) ABSTRACT

A turbidity sensor includes a sensor body, a primary illuminator, a scattered light detector and a bubble illuminator. The sensor body is disposed to contact a liquid sample. The primary illumination source is disposed to direct illumination into the liquid sample. The scattered illumination detector is disposed proximate a portion of the sensor body that is straight in at least one dimension, and the detector is configured to detect illumination from the primary illumination source that is scattered within the liquid sample. A bubble illuminator is disposed to direct illumination along the at least one dimension. Scattered light that originates from the bubble illuminator is detected by the scattered light detector and provides an indication of bubbles proximate the scattered light detector. Methods of filtering and selectively updating a running average of turbidity readings are also disclosed.

### CROSS-REFERENCE TO CO-PENDING APPLICATION

The present application is based on and claims the benefit of U.S. provisional patent application Ser. No. 60/610,325, filed Sep. 16, 2004, the content of which is hereby incorporated by reference in its entirety.

### BACKGROUND OF THE INVENTION

The present invention relates to turbidity sensors.

Turbidity sensors essentially measure the “cloudiness” of a fluid such as water. This measurement is generally done by directing one or more beams of light, either visible or invisible, into the fluid and detecting the degree to which light is scattered off of solid particles suspended in the fluid solution. The resulting turbidity measurement is generally given in Nephelometric Turbidity Units (NTU).

Turbidity measurement systems are used in a wide array of applications including water and waste water monitoring, food and beverage processing, filtration processes, biological sludge control, water quality measurement and management, final effluent monitoring, and even devices such as dishwashers and washing machines.

### SUMMARY OF THE INVENTION

A turbidity sensor includes a sensor body, a primary illuminator, a scattered light detector and a bubble illuminator. The sensor body is disposed to contact a liquid sample. The primary illumination source is disposed to direct illumination into the liquid sample. The scattered illumination detector is disposed proximate a portion of the sensor body that is straight in at least one dimension, and the detector is configured to detect illumination from the primary illumination source that is scattered within the liquid sample. A bubble illuminator is disposed to direct illumination along the at least one dimension. Scattered light that originates from the bubble illuminator is detected by the scattered light detector and provides an indication of bubbles proximate the scattered light detector. Methods of filtering and selectively updating a running average of turbidity readings are also disclosed.

### BRIEF DESCRIPTION OF THE DRAWINGS

FIG. 1 is a diagrammatic view of a turbidity sensing system with which embodiments of the present invention are particularly useful.

FIG. 2 is a diagrammatic view illustrating basic design of optical turbidity sensors.

FIG. 3 is a diagrammatic view of a turbidity sensor in accordance with the prior art.

FIG. 4 is a diagrammatic view of a turbidity sensor in accordance with the prior art illustrating the occurrence of an error induced by a bubble passing through illumination.

FIG. 5 is a diagrammatic view of a portion of a turbidity sensor in accordance with an embodiment of the present invention.

FIG. 6 is a diagrammatic view of a portion of a turbidity sensor in accordance with another embodiment of the present invention.

FIG. 7 is a flow diagram of a method of generating a compensated turbidity output in accordance with an embodiment of the present invention.

FIG. 8 is a flow diagram of a filtering technique to provide a turbidity output in accordance with an embodiment of the present invention.

FIG. 9 is a flow diagram of a method of filtering turbidity readings in accordance with another embodiment of the present invention.

FIG. 10 is a flow diagram of a method of updating a running turbidity measurement average in accordance with an embodiment of the present invention.

### DETAILED DESCRIPTION OF THE PREFERRED EMBODIMENTS

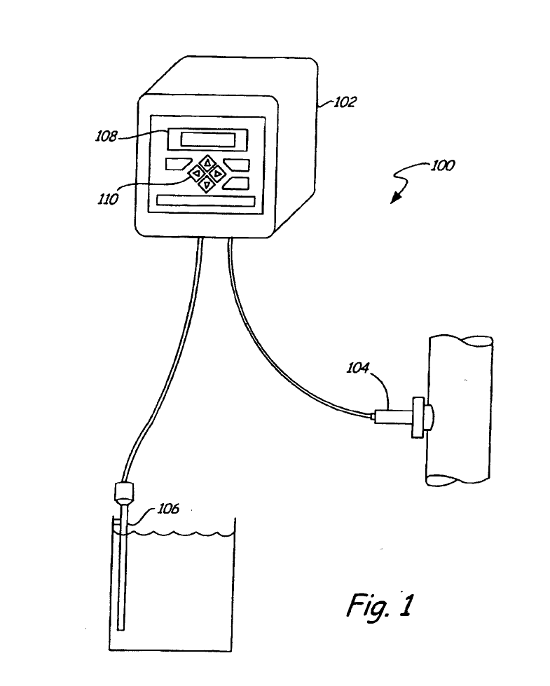

FIG. 1 is a diagrammatic view of turbidity sensing system 100 with which embodiments of the present invention are particularly useful. System 100 includes a turbidity analyzer or meter 102 coupled to one or more turbidity sensors 104, 106. Turbidity sensors may be any suitable types of turbidity sensors including an insertion-type turbidity sensor 104, and/or a submersion-type sensor 106. Further, any type of electromagnetic radiation may be used as illumination for the turbidity sensors. For example, sensors in compliance with U.S. EPA regulation 180.1 that use visible light can be used. Additionally, sensors in accordance with ISO 7027, which use near infrared LEDs may also be employed.

Analyzer 102 preferably includes an output 108 in the form of a display. Additionally, or alternatively, analyzer 102 may have a communication output providing the turbidity readings to an external device. Analyzer 102 also preferably includes a user input in the form of one or more buttons 110. However any suitable input can be used. In fact, analyzer 102 may receive input via a communication interface.

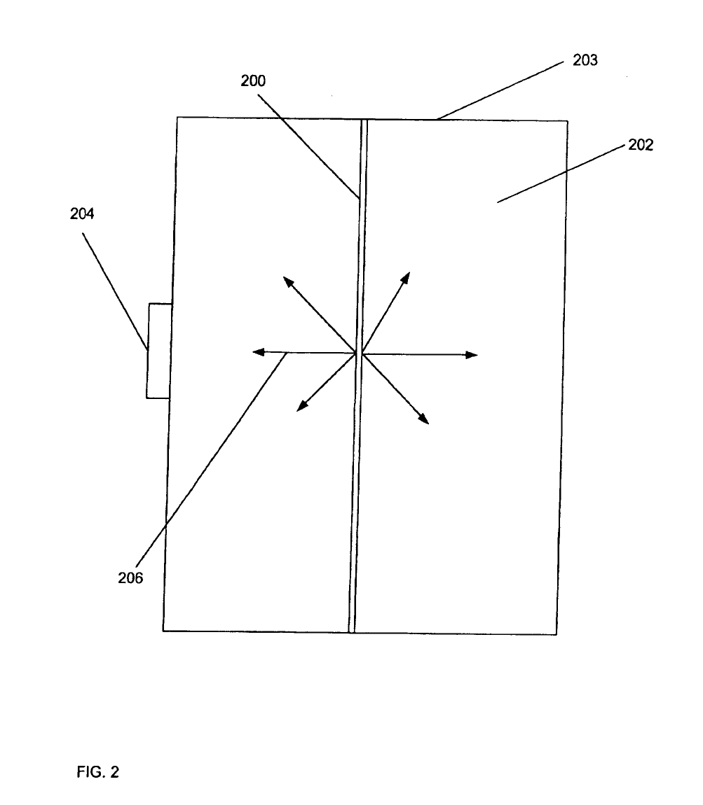

FIG. 2 is a diagrammatic view illustrating basic design of optical turbidity sensors. Generally, a beam 200 of incident illumination is directed through liquid sample 202 within a sample chamber or vessel 203. As beam 200 passes through sample 202, beam 200 collides with particulate matter, such as suspended solids, disposed within sample 202. As a result of the various collisions, a portion of illumination 200 is scattered in various directions, depending on individual collisions. Accordingly, an indication of turbidity is often generated by measuring the degree to which beam 200 is scattered. Thus, disposing scattered light detector 204 at an angle and position such that only some of the scattered illumination 206 is received by detector 204 allows detector 204 to provide a direct indication of turbidity. This scattering of light passing through a liquid sample forms the basis of many optical turbidity sensors in use today. For better results, modern optical turbidity sensors often position scattered light detector 204 at an approximate 90-degree angle relative to incident light beam 200. The turbidity sensor output can then be a simple indication of the relative ratio between the intensity of incident beam 200 and intensity of scattered beam 206 measured by detector 204.

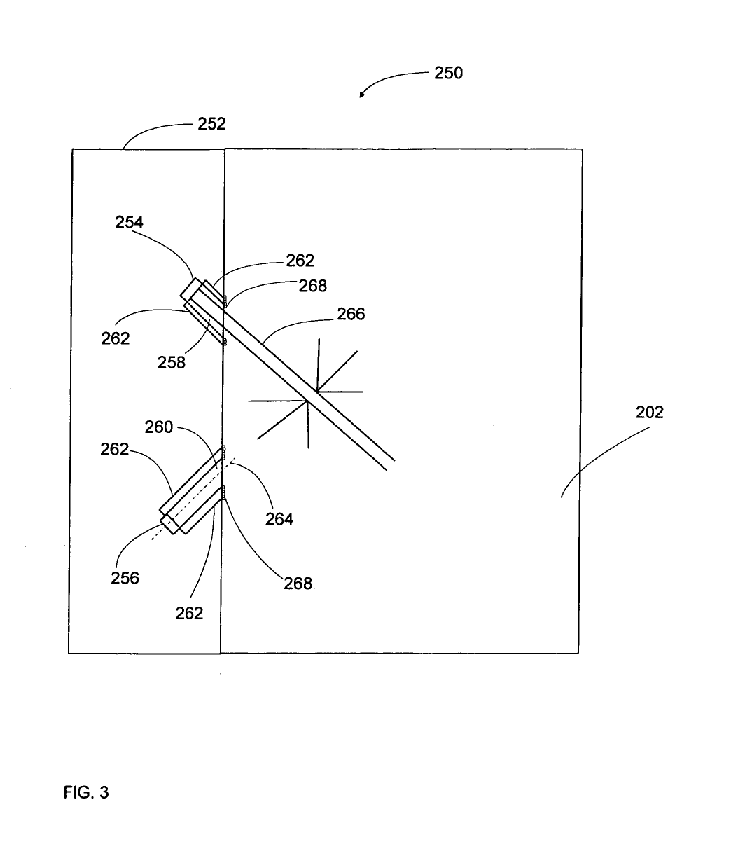

FIG. 3 is a diagrammatic view of a turbidity sensor in accordance with the prior art. Sensor 250 includes sensor body 252, which may be plastic or metal, that is configured to contact liquid sample 202. Sensor body 252 can be a chamber constructed to contain a quantity of sample liquid 202, or sensor body can simply be configured to be submersed in, or otherwise contacted with, liquid sample 202. Sensor body 252 contains incident light source 254 and scattered light detector 256. Each of source 254 and detector 256 are optically coupled with the sample liquid by virtue of lens/windows 258, 260 respectively. Incident light source 254 and lens 258 are mounted within sensor body 252 using adhesive 262. Similarly, detector 256 and lens 260 are mounted in sensor body 252 using adhesive 262. As illustrated, source 254 and detector 256 are generally arranged such that detector 256 has an optical axis 264 that is substantially perpendicular to source beam 266 from source 254.

A number of factors or influences can adversely affect the accuracy of the turbidity measurement. Such factors include, but are not limited to, fleeting variations in the intensity of the illumination used to detect turbidity, and characteristics of the fluid, other than the presence of suspended solids, such as bubbles and/or schlieren that can interact with the incident light beam. For example, bubbles are not suspended solids, but they will interact with light and disperse it when they come into contact with the light beam. This dispersion may erroneously be indicated as turbidity. Providing a turbidity sensor that has the ability to attenuate, or otherwise compensate for, these effects would advance the art of optical turbidity sensors. Embodiments of the present invention achieve this “noise” reduction in various ways.

Bubbles 268 can interact with incident beam 266, or any scattered illumination. Any illumination that is diverted from incident beam 266 by one or more bubbles 268 will cause errors. Similarly, any of the illumination from incident beam 266 that actually collides with a solid, and is later thwarted from being detected by detector 256 by contacting one or more bubbles will also generate errors.

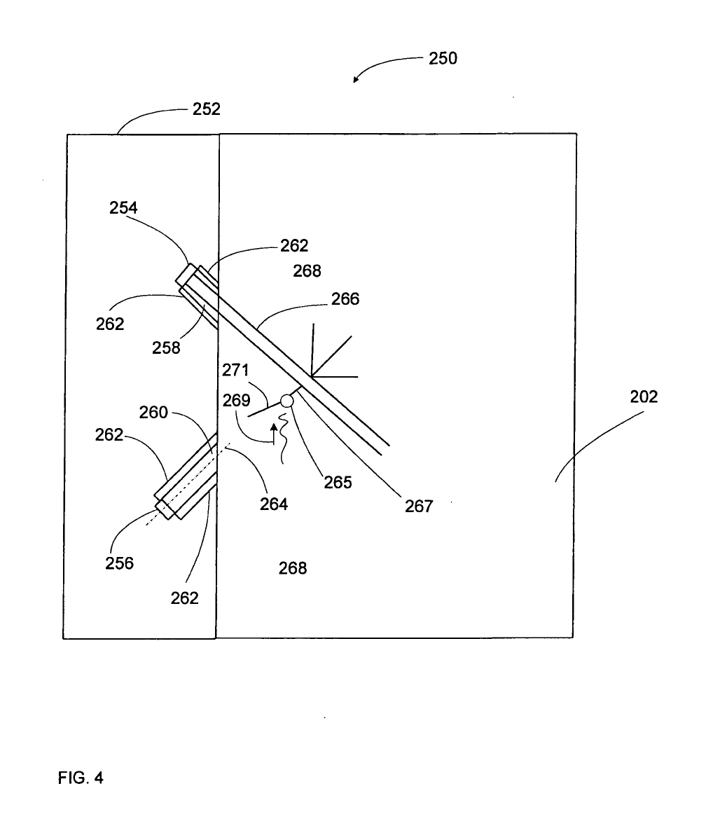

FIG. 4 is a diagrammatic view of a turbidity sensor in accordance with the prior art illustrating the occurrence of an error induced by a bubble passing through illumination. Turbidity sensor 250 is structurally identical to sensor 250 described with respect to FIG. 3. Sensor 250 is susceptible to errors caused by fleeting noise events such as a bubble floating through either the scattered beam, the incident illumination, or both. FIG. 4 shows bubble 265 rising through scattered light beam 267 in the direction indicated by arrow 269. As beam 267 collides with bubble 265, the resultant scattered beam 271 may be deflected from its proper path, and thus not read by sensor 256. This is merely one way in which a floating bubble can generate a turbidity error. Errors are also generated when a bubble, such as bubble 265 collides with incident beam 266 and causes some illumination to be deflected to scattered beam detector 256.

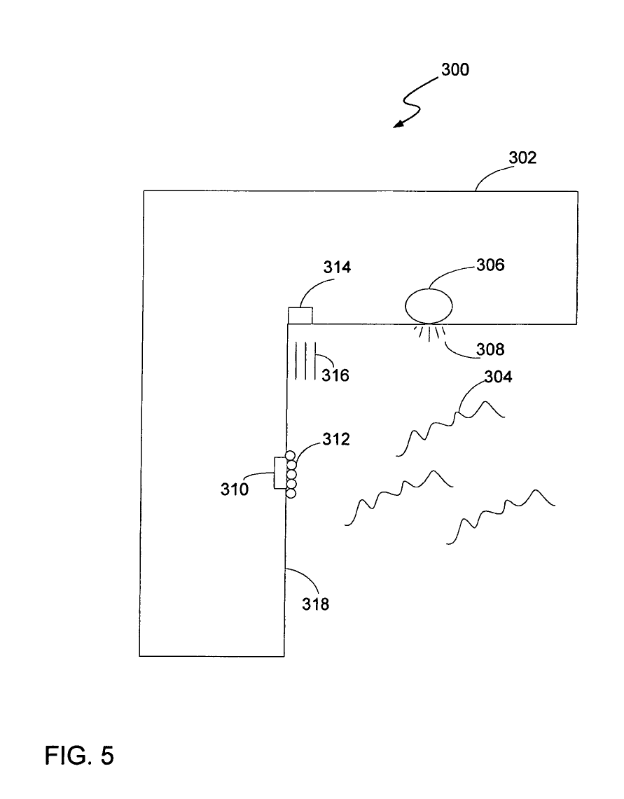

FIG. 5 is a diagrammatic view of a turbidity sensor in accordance with embodiments of the present invention. Turbidity sensor 300 includes sensor body 302 that is adapted to contact, or otherwise be disposed proximate liquid sample 304. Incident light source 306 disposed within, or near sensor body 302 generates incident illumination 308 that is directed into liquid sample 304. As illumination 308 interacts with solids within liquid sample 304, some of illumination 308 is deflected and detected by scattered light detector 310. However, the presence of one or more gas bubbles 312 proximate detector 310 can adversely affect the accuracy of the turbidity measurement. Moreover, fleeting variations in power, or efficiency of illumination source 306 may cause momentary increases or decreases in illumination. These fleeting variations may also be a source of sensor error.

Detector 310 is mounted within or proximate a portion of sensor body 302 that is relatively straight in at least one dimension. For example, sensor body 302 may be cylindrical and thus relatively straight in only one dimension. However, if sensor body 302 is shaped as a box, body 302 would be relatively straight in two dimensions. In accordance with one embodiment of the present invention, illumination source 314 is disposed to generate illumination 316 substantially parallel to the straight dimension (illustrated as reference numeral 318 in FIG. 5). Due to the position and orientation of source 314, illumination 316 will not significantly interact with suspended solids, but will instead collide with gas bubbles 312. The result of this collision is that an indication of the presence, and degree of gas bubbles 312 can be generated using source 314. Preferably, source 314 comprises one or more light emitting diodes that are mounted substantially flush with surface 318. Further still, the detection of bubbles 312 is preferably done when incident illumination source 306 is turned off. That way, only illumination from source 314 that collides with one or more bubbles 312 is detected by detector 310. However, this need not be the case, since source 314 could be adapted to generate illumination that differs from that of source 306. For example, bubble illumination could be of a different wavelength and/or polarization than illumination from source 306. Based on the detection of bubble illumination 316 being scattered, a value or offset representative of the intensity of scattered bubble illumination can be stored within appropriate circuitry, such as a microprocessor, or computer memory (not shown) and later used to correct the unwanted, run-time output of sensor 300 for the effects of bubbles 312.

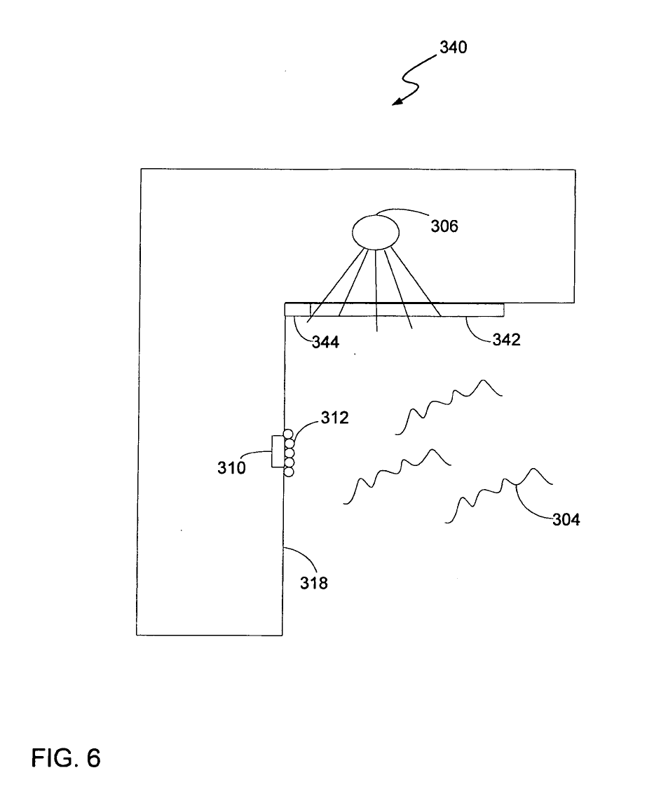

FIG. 6 is a diagrammatic view of a turbidity sensor in accordance with another embodiment of the present invention. Turbidity sensor 340 includes some of the components of sensor 300, and like components are numbered similarly. Sensor 340 differs from sensor 300 in that sensor 340 employs a selectable shutter, or obstruction 342 disposed between incident light source 306 and liquid sample 304. Preferably, shutter 342 can operate as a light switch, using technology such as liquid crystal display technology, to selectively obstruct all or part of the illumination from source 306. It should be noted, while sensor 340 is illustrated as employing a single source 306, multiple such sources could be used. In accordance with an embodiment of the present invention, a portion 344 of shutter 342 can be actuated independently of the rest of shutter 342 such that only portion 344 is allowed to convey light therethrough. In this manner, virtually all of illumination from source 306 can be obstructed by shutter 342, while some illumination proximate region 344 is allowed to pass therethrough and thus be used to detect bubbles 312.

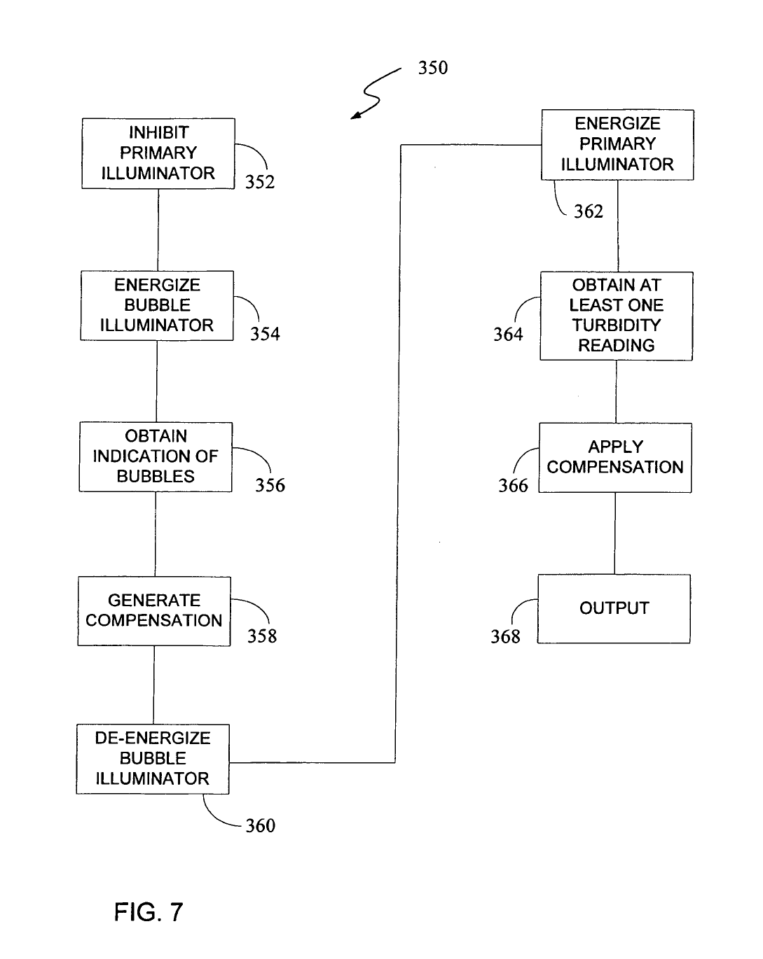

FIG. 7 is a flow diagram of a method 350 for generating a compensated turbidity output in accordance with an embodiment of the present invention. Method 350 is particularly effective at reducing errors from moving bubbles, and other fleeting noise events, such as that described above with respect to FIG. 4. Method 350 begins at block 352 where the primary illuminator, such as illuminator 306 in FIG. 6, is inhibited. This inhibition can be effected by removing power to illuminator 306, or by obstructing it with a shutter, such as shutter 342. After the primary illuminator is inhibited, a bubble illuminator, such as illuminator 314, in FIG. 5, is energized to direct illumination along the plane where bubbles may be present as indicated at block 354. At block 356, the scattered light detector 310 is used to detect illumination that is scattered by bubbles 312 proximate detector 310 while the bubble illuminator is energized. At block 358, a compensation factor, or formula is generated based on the indication of bubbles received at block 356. At block 360, the bubble illuminator is de-energized. Then, at block, 362, the primary illuminator is energized once again. At block 364 one or more turbidity readings are obtained using the primary illuminator and the scattered light detector. Once a sufficient number of turbidity readings have been obtained, which number may include one, the compensation generated at block 358 is applied at block 366. Finally, at block 368, the compensated turbidity output is provided.

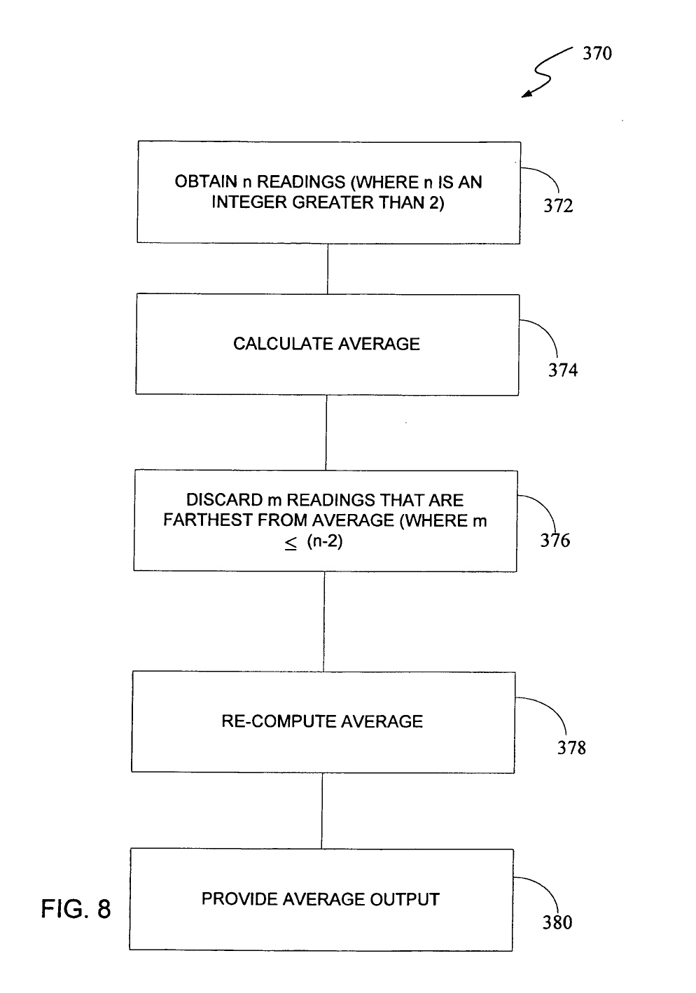

FIG. 8 is a flow diagram of a filtering technique that lends itself well to digital filtering for bubble rejection in turbidity measurements. Method 370 begins at block 372 where n turbidity readings are obtained. As indicated in block 372, n is any integer greater than 2. However, it is preferred that n=3. At block 374, the average of the n readings is calculated. Then, at block 376, a selected number (m) of readings are discarded based on their distance from the average. As indicated at block 376, m is less than or equal to n−2. Thus, in the preferred embodiment where n=3, m will be 1, and thus of the three readings, the farthest reading from the average will be discarded. At block 378, the average of the non-discarded readings is computed. At block 380, the average computation is provided as a turbidity output. In this manner, if a fleeting noise, such as the presence of a bubble, or brief change in illumination intensity occurs during a given turbidity measurement, that single affected turbidity measurement will simply be discarded and the accuracy of the overall turbidity output will be unaffected.

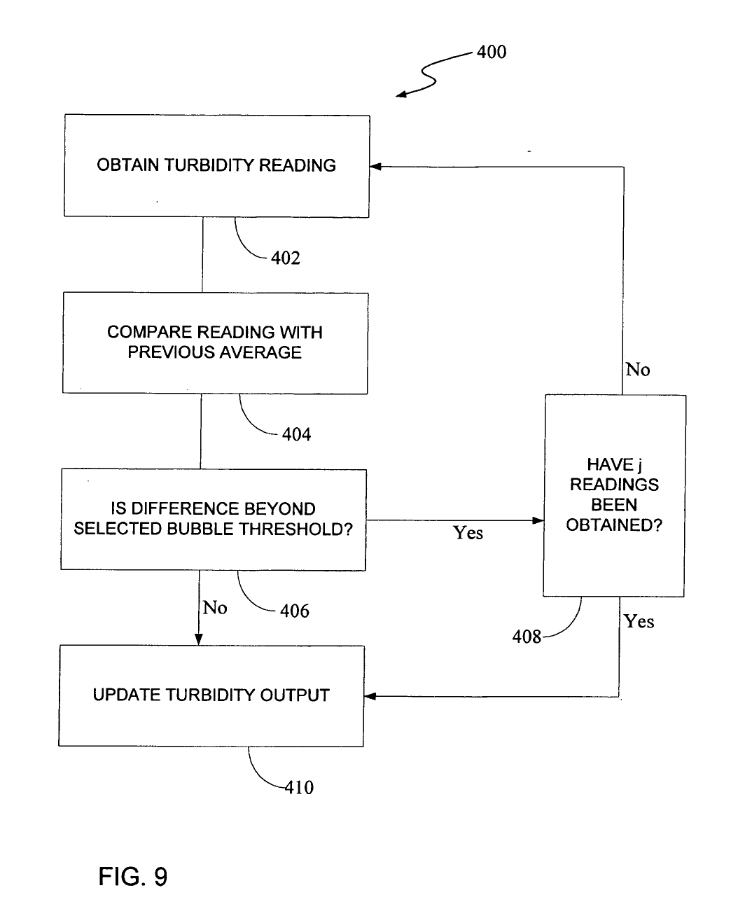

FIG. 9 is a flow diagram of a method 400 of digitally filtering turbidity readings in accordance with an embodiment of the present invention. Method 400 begins at block 402 where a turbidity reading is obtained. At block 404, the turbidity reading obtained at block 402 is compared with a previous running average. If block 402 is executed initially upon device startup, the average can be set to be equal to the first turbidity reading. However, thereafter, the average can be an average of a selected integer number of the most recent turbidity readings. Weighting factors can be used to differentially weight more recent readings in comparison to older readings, for example. Once the comparison of block 404 is completed, block 406 inquires whether the difference between the turbidity reading obtained at block 402 and the previous average is beyond a selected bubble threshold. This threshold can be selected manually by a user or provided as a function of previous turbidity measurements. If the turbidity measurement is beyond, or larger than, the selected bubble threshold, control passes to block 408, which determines whether j readings have been obtained that are beyond the selected bubble threshold. If j readings have not been obtained, block 408 returns control to block 402 where yet another turbidity reading is obtained. If, however, block 408 determines that j readings have been obtained, then control is passed to block 410, which updates the turbidity output as well as the running average. Block 410 is also the destination of block 406 when the difference between the turbidity reading and the previous average is not beyond the selected bubble threshold. In this manner, an unexpected variation in turbidity readings, such as that generated by the movement of air bubbles, or fleeting variations in temperature or illumination intensity can effectively be blocked from the output. However, if the occurrence lasts beyond the time required to obtain j readings, then the turbidity reading will reflect the disturbance. The selected number of j readings is preferably a function of the averaging time selected by the user. Therefore, this will create a larger bubble/noise blocking factor when larger averaging is selected. Additionally, the integer j can also be a function of the running average, a function of the combination of the averaging time and the weight of the running average, or any other suitable combination.

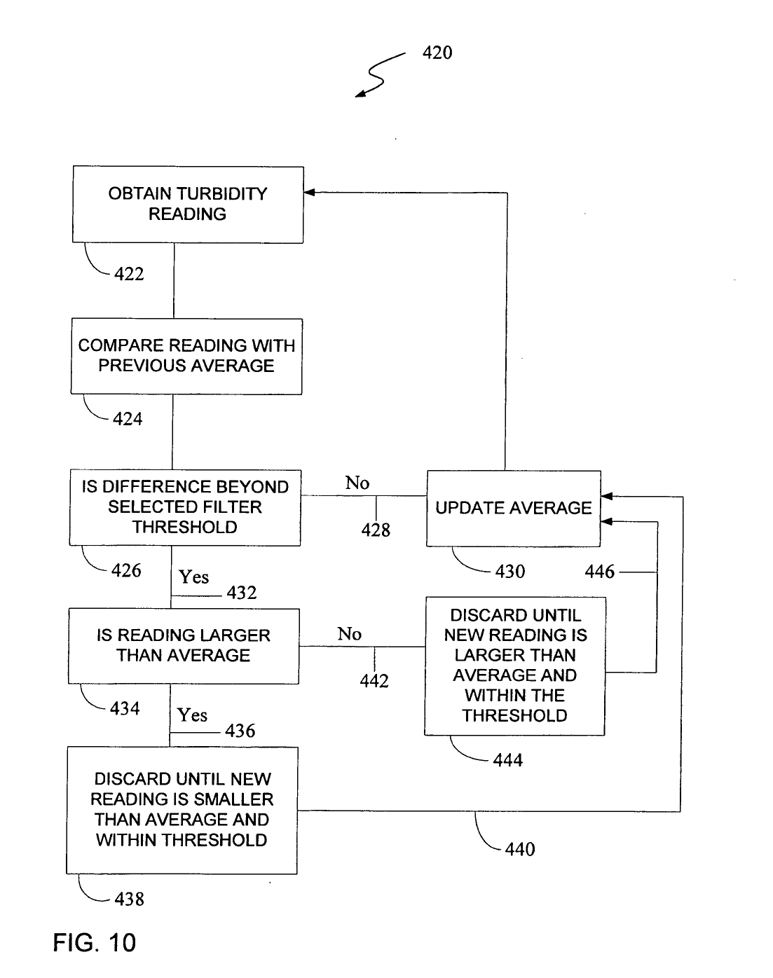

FIG. 10 is a flow diagram of a method of updating a running turbidity average in accordance with an embodiment of the present invention. Method 420 begins at block 422 where a turbidity measurement is obtained. At block 424 the turbidity measurement is compared with a previous running average. At block 426 it is determined whether the difference between the turbidity measurement and the previous average is beyond a selected filter threshold. If the turbidity measurement difference is not beyond the selected filter threshold, then control passes along line 428 to block 430 where the running average is updated with the turbidity measurement obtained at block 422. Then, control returns to block 422 and the method repeats. If, however, block 426 determines that the difference between the turbidity measurement and the previous running average is beyond the selected filter threshold, then control passes along line 432 to block 434. Block 434 determines whether the turbidity measurement has parted from the previous average in a positive, or negative departure. If the turbidity reading is larger than the average, or in other words the reading has jumped, control passes along line 436 to block 438. At block 438, the method obtains and discards new turbidity readings until a reading is obtained that is smaller than the average (in the opposite direction of the original departure) and is within the selected filter threshold. When this occurs, control passes along line 440 to block 430 where the running average is updated. Similarly, if the departure is in the negative-going direction, control from block 434 passes along line 442 to block 444. Block 444 obtains and discards new turbidity readings until one is obtained that is larger than the average and within the selected threshold. Then, control passes to block 430 along line 446 where the running average is updated. In this manner, the running average is only updated with turbidity readings that are within the selected filter threshold. In this manner, spurious data, such as generated from the noise of bubbles, or fleeting changes of temperature or illumination intensity can be ameliorated.

While specific electronic circuits have not been disclosed relative to the turbidity sensors described herein, it is noted that any suitable, commercially available technology may be used to drive the illuminator and/or generate illumination detection via detectors. Although the present invention has been described with reference to preferred embodiments, workers skilled in the art will recognize that changes may be made in form and detail without departing from the spirit and scope of the invention.

What is claimed is:

1. A sensor for sensing turbidity of a liquid sample, the sensor comprising:
a sensor body disposed to contact a liquid sample;
a primary illumination source disposed to direct illumination into the liquid sample;
a scattered illumination detector disposed proximate a portion of the sensor body that is straight in at least one dimension, the detector being configured to detect illumination from the primary illumination source that is scattered within the liquid sample; and
a bubble illuminator disposed to direct illumination along the at least one dimension, wherein scattered light detected by the scattered light detector that originates from the bubble illuminator provides an indication of bubbles proximate the scattered light detector.

2. The sensor of claim 1, and further comprising a shutter configured to inhibit illumination directed into the liquid sample.

3. The sensor of claim 2, wherein the shutter has a first portion disposed proximate the primary illumination source, and a second potion disposed proximate the bubble illuminator.

4. The sensor of claim 3, wherein the shutter is a liquid crystal shutter.

5. The sensor of claim 1, wherein the primary illumination source generates visible illumination.

6. The sensor of claim 1, wherein the primary illumination source and the bubble illuminator each generate illumination having a different characteristic than the other.

7. The sensor of claim 6, wherein the characteristic is wavelength.

8. The sensor of claim 6, wherein the characteristic is polarization.

9. A sensor for sensing turbidity of a liquid sample, the sensor comprising:
a sensor body disposed to contact a liquid sample;
a primary illumination source disposed to direct illumination into the liquid sample;
a scattered illumination detector disposed proximate a portion of the sensor body that is straight in at least one dimension, the detector being configured to detect illumination from the primary illumination source that is scattered within the liquid sample; and
a shutter having a first region proximate the primary illumination source, and a second region disposed to pass illumination along the at least one dimension, wherein the first region is configured to selectively inhibit illumination directed into the liquid sample.

10. The sensor of claim 9, wherein the shutter is a liquid crystal shutter.

11. A method of generating a compensated turbidity output, the method comprising:
directing bubble illumination along a substantially straight line proximate a scattered light detector;
detecting scattered illumination with the scattered light detector;
storing a value relative to the detected scattered illumination;
inhibiting the bubble illumination;
directing primary illumination into a liquid sample;
detecting scattered primary illumination with the scattered light detector; and
generating a turbidity output based on the detected scattered primary illumination and the stored value.

12. A method of generating a turbidity output, the method comprising:
obtaining n turbidity readings (where n>=3);
calculating an average of all n readings;
identifying at least m turbidity reading(s) (where m<=(n−2) that have the largest difference from the average;
discarding the m turbidity readings;
generating a turbidity output based on remaining n−m readings.

13. The method of claim 12, wherein generating the turbidity output includes calculating an average of the remaining n−m readings.

14. A method of selectively updating a running turbidity average, the method comprising:
obtaining a turbidity reading;
calculating a difference between the turbidity reading and the running turbidity average;
comparing the difference with a bubble threshold; and
selectively updating the running average based upon the comparison.

15. The method of claim 14, wherein selectively updating includes repeating the steps of obtaining a turbidity reading; calculating the difference; and comparing the difference with the bubble threshold; until a turbidity reading is obtained within the bubble threshold.

16. The method of claim 14, wherein selectively updating includes repeating the steps of obtaining a turbidity reading; calculating the difference; and comparing the difference with the bubble threshold; until a selected number (j) turbidity readings have been obtained.

17. A method of selectively updating a running turbidity average, the method comprising:
obtaining a turbidity reading;
calculating a difference between the turbidity reading and the running turbidity average;
comparing the difference with a selected filter threshold; and
selectively updating the running average based upon the comparison.

18. The method of claim 14, wherein selectively updating includes repeating the steps of obtaining a turbidity reading; calculating the difference; and comparing the difference with the selected filter threshold; until a later turbidity reading is obtained within the selected filter threshold.

19. The method of claim 18, wherein selectively updating includes repeating the steps of obtaining a turbidity reading; calculating the difference; and comparing the difference with the selected filter threshold; until the later turbidity reading is obtained within the selected filter threshold and the difference between the first turbidity measurement and the running average has a sign (+/−) that is different than a sign of the difference between the later turbidity reading and the running average.
